(19) United States
(12) Patent Application Publication
(10) Pub. No.: US 2015/0014508 A1
(43) Pub. Date: Jan. 15, 2015

(54) FRAME, SYSTEM AND/OR METHOD FOR DEPLOYING A SKID

(71) Applicant: M-I L.L.C., Houston, TX (US)

(72) Inventor: Joe M. Sherwood, Columbus, TX (US)

(21) Appl. No.: 14/327,612

(22) Filed: Jul. 10, 2014

Related U.S. Application Data
(60) Provisional application No. 61/844,777, filed on Jul. 10, 2013.

(51) Int. Cl. F16M 11/24

(52) U.S. Cl. CPC F16M 11/24
USPC 248/558

(57) ABSTRACT

A frame, a system and/or a method deploys a compact skid. The compact skid has a storage position and an operational position. The compact skid has an inner shell, an outer shell and a bladder. In the storage position, the inner shell is positioned within the volume of the outer shell. To expand the compact skid from the storage position to the operational position, an air compressor is connected to the bladder. The bladder is inflated to lift the inner shell vertically. When the inner shell is lifted, the inner shell is locked into place to the outer shell. The bladder is then partially deflated, and the air compressor is disconnected.

### CROSS-REFERENCE TO RELATED APPLICATIONS

This application claims the benefit of U.S. Provisional Patent Application No. 61/844,777, filed Jul. 10, 2013, the disclosure of which is incorporated herein by reference.

### BACKGROUND

The present disclosure generally relates to a frame, a system and/or a method for deploying a compact skid. More specifically, the present disclosure relates to an apparatus, a system and a method for deploying a skid that transitions between a storage position and an operational position using an air bladder. In the storage position, the skid is compact and may be shipped or stored.

In the field of on-shore oil drilling, drilling sites are often located in remote areas. Constructing a drilling rig in these remote areas has several challenges. The drilling rig often has multiple systems, such as fluid control systems, divided into subsystems. Because of the remoteness, the subsystems are designed and assembled off-site. These subsystems are then transported and deployed at the drilling site.

Additionally, the available footprint for the drilling rig is limited. To fit into the limited area, the subsystems often have vertical components. To avoid additional costs, these subsystems are designed to be compact and ready to be shipped. As a consequence, the subsystems are not designed to have tall vertical components. Therefore, the subsystems often have frames that allow the subsystems to be stacked.

However, in these remote areas, some support equipment, such as cranes, may not be available. Even if cranes are available, a construction bottle neck may form if multiple subsystems have vertical components that require lifting and stacking A heavier subsystem requires a larger crane. Therefore, if a crane is available, the crane must be designed for the heaviest subsystem. Building a bigger crane requires more space and resources.

Hydraulic or pneumatic lifts may be built into the frame of the subsystem. Using the lifts, a portion of the subsystem may be lifted off the ground to provide more vertical room. For example, a subsystem that required conduits below the equipment of the subsystem may lift itself to make more space to fit the conduits. However, this approach becomes more impractical as the subsystem gets heavier. Heavier subsystems require larger hydraulic or pneumatic lifts.

### BRIEF DESCRIPTION OF THE DRAWINGS

FIG. 1 illustrates an isometric view of an embodiment of a skid.

FIG. 2 illustrates an isometric view of an embodiment of an outer shell of the skid.

FIG. 3 illustrates an isometric view of an embodiment of an inner shell of the skid.

FIG. 4 illustrates a side view of an embodiment of the skid in an operational position.

FIG. 5 illustrates a side view of an embodiment of the skid in a storage position.

FIG. 6 illustrates a side view of an embodiment of the skid with a fully inflated air bladder.

### DETAILED DESCRIPTION

The present disclosure generally relates to a frame, a system and/or a method for deploying a compact skid. More specifically, the present disclosure relates to an apparatus, a system and a method for deploying a skid that transitions between a storage position and an operational position using an air bladder. The storage position may be compact while the operational position may be expanded.

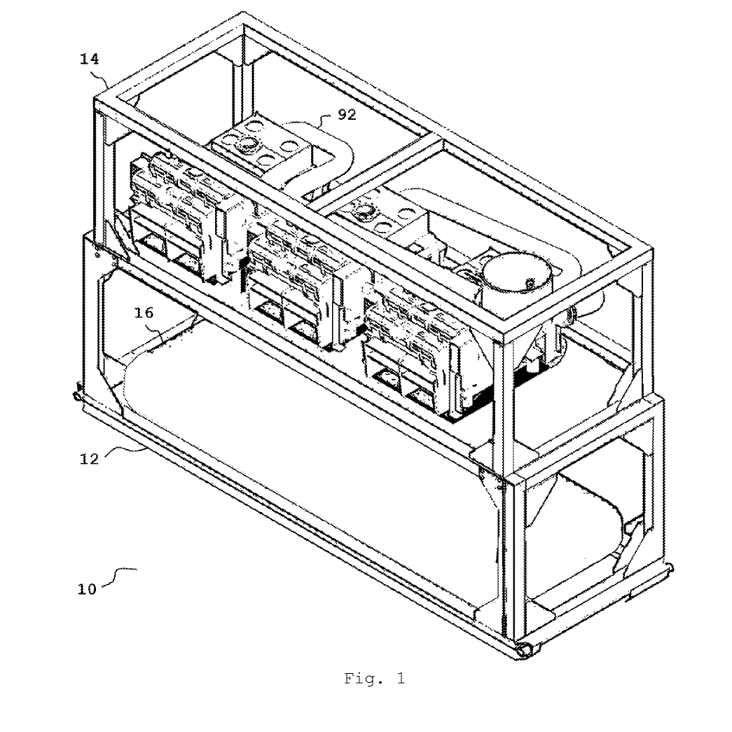

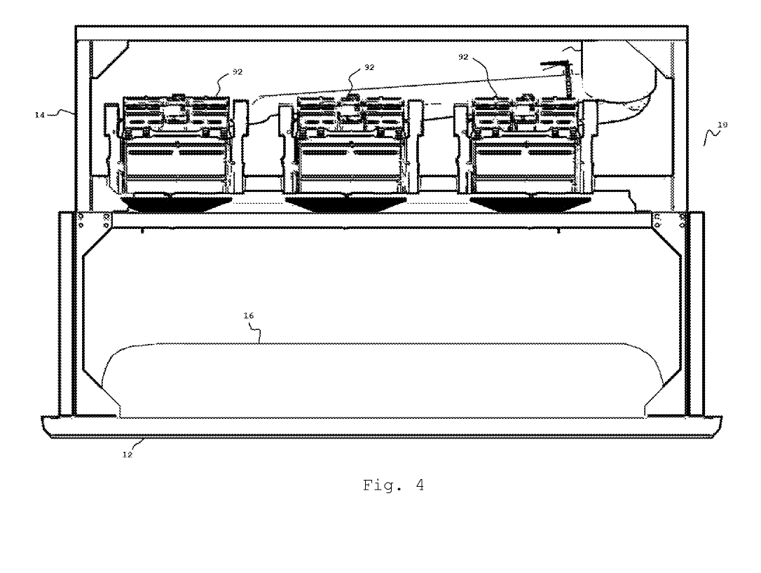

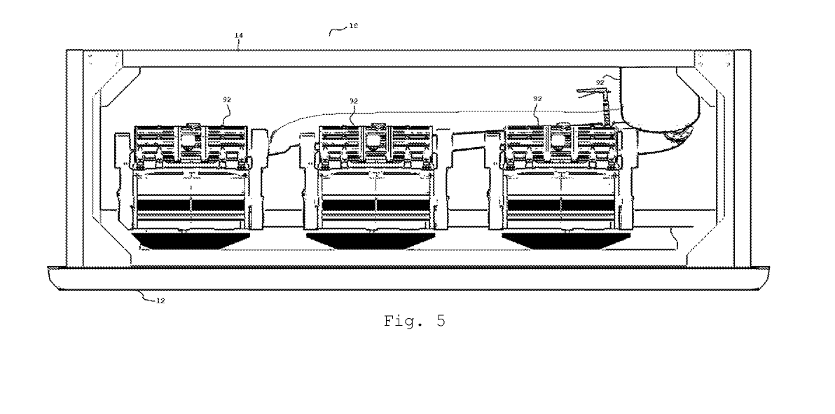

Referring to the drawings wherein like numerals refer to like parts, FIG. 1 and FIGS. 4-6 generally illustrate a skid 10 that may have a storage position and an operational position. FIGS. 1 and 4 illustrate an embodiment of the skid 10 in the operational position. FIG. 5 illustrates an embodiment of the skid 10 in the storage position. The skid 10 may have an outer shell 12, an inner shell 14 and an air bladder 16.

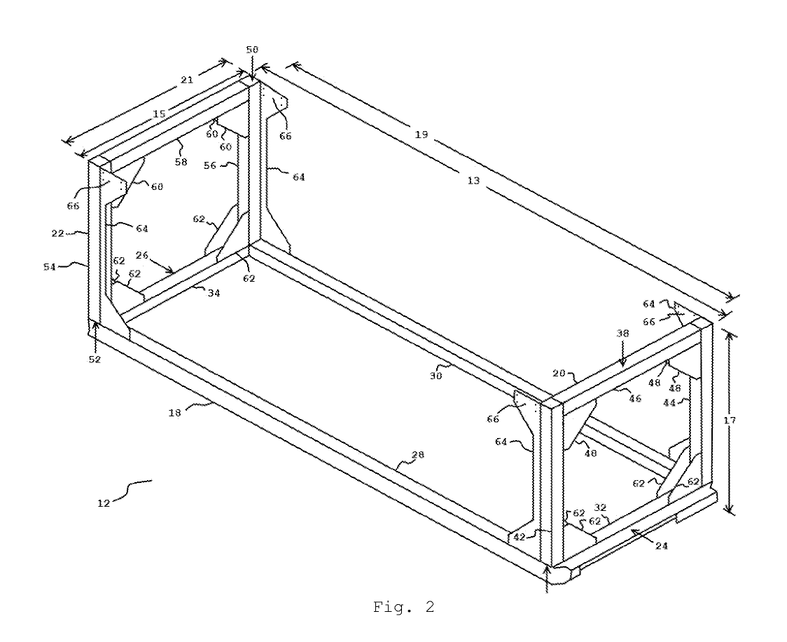

As illustrated in FIG. 2, the outer shell 12 may have a base 18, a front end frame 20 and a back end frame 22. Together, the base 18, the front end frame 20 and the back end frame 22 may define a volume with the outer shell 12, an outer length 13, an outer width 15, an outer height 17, an inner length 19 and an inner width 21.
a. The base 18 may have a front end 24 and a back end 26. The base 18 may be formed by a first side rail 28, a second side rail 30, a front cross member 32 and a back cross member 34. The first side rail 28, the second side rail 30, the front cross member 32 and the back cross member 34 may be orthogonally connected together. The first side rail 28 may be parallel to the second side rail 30. Additionally, the front cross member 32 may be parallel to the back cross member 34. The front cross member 32 may be attached to the first side rail 28 and the second side rail 30 at the front end 24 of the base 18. The back cross member 34 may attached to the first side rail 28 and the second side rail 30 at the back end 26 of the base 18. In an embodiment, the base 18 may also have one or more support cross members connecting the first side rail 28 and the second side rail 20 between the back cross member 34 and the front cross member 32.

The front end frame 20 may have a top 38 and a bottom 40. The front end frame 20 may be formed by a first corner post 42, a second corner post 44 and a first top cross member 46. The first corner post 42 and the second corner post 44 may be orthogonally connected to the first top cross member 46 at the top 38 of the front end frame 20. The first corner post 42 may be parallel to the second corner post 44. A plurality of front gussets 48 may reinforce the connection between the first corner post 42 with the first top cross member 46. Additionally, the plurality of front gussets 48 may reinforce the connection between the second corner post 44 with the first top cross member 46.

The back end frame 22 may have a top 50 and a bottom 52. The back end frame 22 may be formed by a third corner post 54, a fourth corner post 56 and a second top cross member 58. The third corner post 54 and the fourth corner post 56 may be orthogonally connected to the second top cross member 58 at the top 50 of the back end frame 22. The third corner post 54 may be parallel to the fourth corner post 56. A plurality of back gussets 60 may reinforce the connection between the third corner post 54 with the second top cross member 58. Further, the plurality of back gussets 60 may reinforce the connection between the fourth corner post 56 with the second top cross member 58.

The front end frame 20 may be connected to the front end 24 of the base 18. The front cross member 32 of the base 18 may be parallel to the first top cross member 46 of the front end frame 20. The back end frame 22 may be connected to the back end 26 of the base 18. The back cross member 34 of the base 18 may be parallel to the second top cross member 58 of the back end frame 22. A plurality of support gussets 62 may reinforce the connection between the base 18 and the front end frame 20. Additionally, the plurality of support gussets 62 may reinforce the connection between the base 18 and the back end frame 22.

The outer shell 12 may have a plurality locking supports 64. One of the plurality of locking supports may be attached to the first corner post 42 of the front end frame 20 and the first side rail 28 of the base 18. One of the plurality of locking supports may be attached to the second corner post 44 of the front end frame 20 and the second side rail 30 of the base 18. The plurality of locking supports 64 connected to the front end frame 20 may extend from the bottom 40 to the top 38 of the front end frame 20. Additionally, one of the plurality of locking supports 64 may be attached between the third corner post 54 of the back end frame 22 and the first side rail 28 of the base 18. Finally, one of the plurality of locking supports 64 may be attached between the fourth corner post 56 of the back end frame 22 and the second side rail 30 of the base 18. Each locking support 64 may have a plurality of primary pin holes 66. The plurality of locking supports 64 connected to the back end frame 22 may extend from bottom 52 to the top 50 of the back end frame 22. The plurality of primary pin holes 66 of each locking support 64 may be used to lock the skid 10 into either the storage position or the operational position.

The outer length 13, the outer width 15 and the outer height 17 of the outer shell 12 may conform to size requirements of the ISO 6346 standard. For example, in an embodiment, the outer length 13, outer width 15 and the outer height 17 of the outer shell 12 may conform the dimensions of a twenty foot intermodal shipping container. Alternatively, the outer length 13, outer width 15 and the outer height 17 of the outer shell 12 may conform to the dimensions of a forty foot intermodal shipping container. However, the outer length 13, the outer width 15, and/or the outer height 17 of the outer shell 12 are not limited to the dimensions of the twenty foot intermodal container or the dimensions of the forty foot intermodal container.

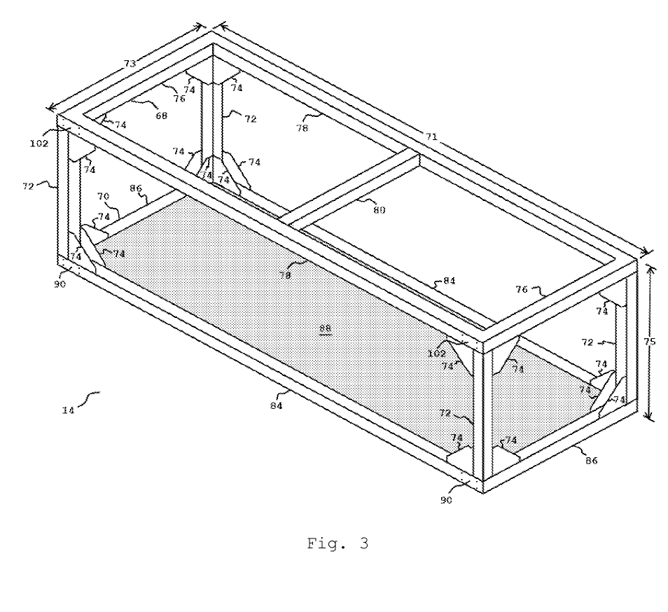

FIG. 3 illustrates an embodiment of the inner shell 14 of the skid 10. The inner shell 14 may have a top frame 68, a bottom frame 70 and a plurality of corner posts 72. The plurality of corner posts 72 may connect the top frame 68 to the bottom frame 70. The top frame 68 and the bottom frame 70 may be parallel. A plurality of gussets 74 may reinforce the connection between the plurality of corner posts 72 and the top frame 68. Similarly, the plurality of gussets 74 may reinforce the connection between the plurality of corner posts 72 and the bottom frame 70. The top frame 68, the bottom frame 70 and the plurality of corner posts 72 may define an inner volume, an outer length 71, an outer width 73 and an outer height 75.

The top frame 68 may be formed by two end cross members 76 orthogonally connecting opposite ends of two parallel side rails 78. A support cross member 80 may connect the parallel side rails 78 between the two end cross members 76. Each end of each of the two parallel side rails 78 may have a plurality of storage pin holes 102. The storage pin holes 102 may be used to lock the skid 10 into the storage position.

The bottom frame 70 may be formed by two end cross members 82 orthogonally connected to opposite ends of two parallel side rails 84. A plurality of support cross members 86 may connect the two parallel side rails 84 between the two end cross members 82. A floor panel 88 may be attached to the plurality of support cross members 86. Each end of each of the two parallel side rails 84 may have a plurality of operational pin holes 90. The operational pin holes 90 may be used to lock the skid 10 into the operational position.

The outer length 71, the outer width 73 and the outer height 75 of the inner shell 14 may be configured so that the inner shell 14 fits within the inner volume of the outer shell 12. The outer width 73 of the inner shell 14 may substantially equal the inner width 21 of the outer shell 12. Similarly, the outer length 71 of the inner shell 14 may substantially equal the inner length 19 of the outer shell 12.

Equipment 92 may be situated on the floor panel 88 of the bottom frame 70 of the inner shell 14. In one embodiment, the equipment 92 may be one or more shale shakers and/or one or more dryers. The equipment 92 may also include mud mixers, chemical storage and/or control systems.

The air bladder 16 may be situated between the inner shell 14 and the outer shell 12. In the storage position, the air bladder 16 may be located within a volume defined by the first side rail 28, the second side rail 30, the front cross member 32 and the back cross member 34 of the base 18 of the outer shell 12 and the floor panel 88 of the bottom frame 70 of the inner shell 14. When the skid 10 is not in the storage position, the air bladder 16 may expand to fill at least a portion of the inner volume of the outer shell 12.

As shown in FIG. 5, in the storage position, the inner shell 14 may be located within the inner volume of the outer shell 12. Additionally, the equipment 92 may be contained within the volume of the inner shell 14. In the storage position, the skid 10 may be loaded onto a flat bed truck, transported to the intended destination, and unloaded. The skid 10 may be shipped by truck, train, airplane, boat or any other means of transportation normally used to ship intermodal containers. Additionally, the skid 10 may be stored on-site or off-site in the storage position. Further, a cover may be placed over the inner shell 14 and the outer shell 12 above the base 18 to protect the skid while in the storage position.

In an embodiment, when the skid 10 is in the storage position, a portion of the bottom frame 70 of the inner shell 14 may sit on top of a portion of the base 18 of the outer shell 12. Additionally, the top frame 68 of the inner shell 14 may be substantially flush with the top 38 of the front end frame 20 of the outer shell 12 and the top 50 of the back end frame 22 of the outer shell 12. In the storage position, the storage pin holes 102 of the two parallel side rails 78 of the top frame 68 of the inner shell 14 may align with the primary pin holes 66 of the plurality of support members 64 of the outer shell 12. A plurality of pins 96 may be inserted into the primary pin holes 66 of the plurality of support members 64 of the outer shell 12 and the storage pin holes 102 of the two parallel side rails 78 of the top frame 68 of the inner shell 14 to lock the skid 10 into the storage position.

To transition the skid 10 from the storage position to the operation position, an air compressor 94 may be connected to the air bladder 16. The air compressor 94 may inflate the air bladder 16. The air compressor 94 may supply a relatively small amount of pressure. In an embodiment, the air compressor may supply seven to ten PSI of pressure. The air bladder 16 may lift the inner shell 14. As the air bladder 16 inflates, the plurality of locking members 64 may guide the inner shell 14 to ensure that the inner shell 14 stays within the inner length 19 and the inner width 21 of the outer shell 12.

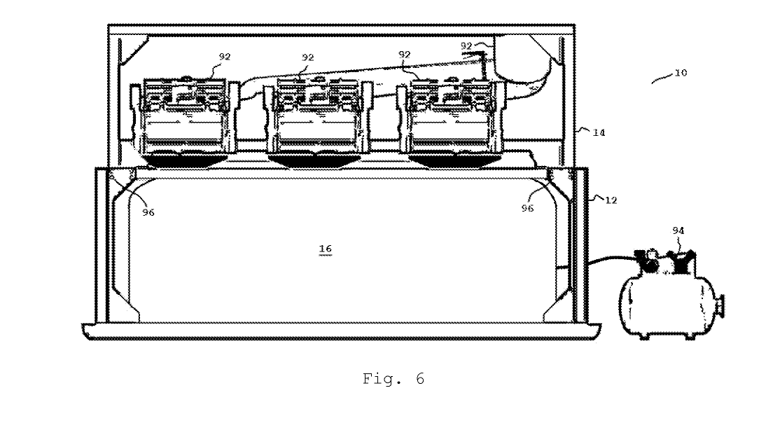

The air bladder 16 may lift the inner shell 14 until the plurality of operational pin holes 90 on the two parallel side rails 84 of the bottom frame 70 of the inner shell 14 align with the plurality of primary pin holes 66 on the plurality of locking members 64 of the outer shell 12. FIG. 6 illustrates the air bladder 16 fully inflated. The plurality of pins 96 may be inserted into the primary pin holes 66 and the operation pin holes 90 to lock the skid 10 into the operational position. Subsequently, as shown in FIGS. 1 and 4, the air bladder 16 may be partially deflated.

In an embodiment, the plurality of pins 96 may be manually installed. Alternatively, the plurality of pins 96 may be spring loaded so that the plurality of pins 96 automatically insert into the primary pin holes 66 and the operation pin holes 90 when the primary pin holes 66 and the operation pin holes 90 are aligned.

FIGS. 1 and 4 illustrate an embodiment of the skid 10 in the operational position with the air bladder 16 partially deflated. In the operational position, the bottom frame 70 of the inner shell 14 may be aligned with the first top cross member 46 of the front end frame 20 of the outer shell 12 and the second top cross member 58 of the back end frame 22 of the outer shell 12. Additionally, the equipment 92 may be expanded or connected to other systems so that a portion of the equipment 92 is no longer contained within the volume of the inner shell 14. In an embodiment, the equipment 92 may be connected to conduit to deliver a slurry to the equipment 92 and to remove drilling fluid from the equipment 92. A power connection may also be connected to the equipment 92. Additionally, safety equipment, such as walkways, guard rails and/or stairs, may be installed onto the skid 10. Other support equipment, such as a shaker pit to collect the solids separated by a shale shaker, may be installed next to the skid 10.

To transition the skid 10 from the operational position to the storage position, the air bladder 16 may be reinflated with the air compressor 94 until the air bladder 16 supports the inner shell 14. The equipment 92 may be adjusted to fit completely within the volume of the inner shell 14. The plurality of pins 96 may be removed from the primary pin holes 66 and the operational pin holes 90. The air bladder 16 may be deflated until the inner shell 14 is within the volume of the outer shell 12 and the primary pin holes 66 and the storage pin holes 102 are aligned. The plurality of pins 96 may be inserted into the primary pin holes 66 and the storage pin holes 102 to lock the skid 10 into the storage position.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the present disclosure should be limited only by the attached claims.

1. A method comprising:
providing a frame having an inner shell and an outer shell wherein the outer shell defines an interior volume;
arranging a bladder between the inner shell and the outer shell; and
inflating the bladder to move the inner shell from a first position relative to the outer shell to a second position relative to the outer shell wherein the second position is above the first position.

2. The method of claim 1 further comprising:
controlling movement of the inner shell relative to the outer shell by adjusting inflation of the bladder.

3. The method of claim 1 wherein the inner shell is located within the interior volume of the outer shell in the first position.

4. The method of claim 1 wherein the inner shell is located above the outer shell in the second position.

5. The method of claim 1 further comprising:
connecting an air source to the bladder.

6. The method of claim 1 further comprising:
inflating the bladder to displace the interior volume.

7. The method of claim 1 further comprising:
elevating the inner shell relative to the outer shell.

8. The method of claim 1 further comprising:
connecting the inner shell to the outer shell.

9. The method of claim 1 further comprising:
deflating the bladder with the inner shell in the second position relative to the outer shell.

10. The method of claim 1 further comprising:
storing the inner shell within the interior volume of the outer shell.

11. The method of claim 1 further comprising:
transporting the frame with the inner shell within the interior volume of the outer shell.

12. The method of claim 1 further comprising:
arranging equipment on the inner frame.

13. A frame comprising:
an inner shell having a top portion, a bottom portion and a plurality of corner posts wherein the plurality of corner posts align to connect the top portion to the bottom portion;
an outer shell having a base, a front end and a back end wherein the base, the front end and the back end are configured to define a volume within the outer shell; and
a bladder on the base and configured to move the inner shell to a position relative to the outer shell.

14. The frame of claim 13 wherein the inner shell fits within the volume of the outer shell.

15. The frame of claim 13 further comprising:
a locking mechanism configured to connect the inner shell to the outer shell.

16. The frame of claim 13 further comprising:
a gusset connected to each one of the plurality of corner posts and the inner shell.

17. The frame of claim 13 further comprising:
a floor panel on the bottom frame of the inner shell.

18. A system comprising:
a skid having a first frame and a second frame wherein the second frame defines a volume;
an inflation device located between the first frame and the second frame wherein the inflation device moves the first frame within the volume of the second frame; and
equipment arranged on the inner frame.

19. The system of claim 18 wherein the first frame and the second frame each have a substantially cubic shape.

20. The system of claim 18 wherein the first frame is contained within the volume of the second frame.
